(19) United States
(12) Patent Application Publication
(10) Pub. No.: US 2026/0277758 A1
(43) Pub. Date: Sep. 17, 2026

(54) FAULT AGGREGATION AND REMAPPING IN AN ELECTRONIC SYSTEM

(71) Applicant: ARTERIS, INC., Campbell, CA (US)

(72) Inventors: Xavier VAN RUYMBEKE, Montigny-le-Bretonneux (FR); Michael MORIAUD, Elancourt (FR); Jean-Christophe PELLION, Poissy (FR); Frederic GREUS, Epernon (FR); Christopher PEZLEY, Versailles (FR)

(73) Assignee: ARTERIS, INC., Campbell, CA (US)

(21) Appl. No.: 19/079,497

(22) Filed: Mar. 14, 2025

(51) Int. Cl. G06F 11/27; G06F 11/07; G06F 11/22

(52) U.S. Cl. CPC G06F 11/27; G06F 11/076; G06F 11/2236

(57) ABSTRACT

An electronic system includes a network-on-chip (NoC) and a fault aggregation circuit. The NoC includes a plurality of NoC components that generate faults. The fault aggregation circuit is configured to receive the faults from the NoC components and aggregate and remap the faults into a few alarm levels.

### TECHNICAL FIELD

The present technology is in the field of electronic systems and more specifically related to electronic systems using a network on chip.

### BACKGROUND

Network-on-chip (NoC) technology is being used at many semiconductor companies to support an ever-increasing number of cores on a single chip and a demand for ever-increasing processing power related to artificial intelligence (AI) and other applications. An NoC is superior to point-to-point connectivity by way of a more scalable communication architecture that makes use of packet transmissions.

A system on chip (SoC) may include a NoC to handle communication between Intellectual Property (IP) units of the SoC. During communication, numerous components of the NoC may generate faults. Some of the faults are correctable, and some are not.

### SUMMARY

In accordance with various embodiments and aspects herein, an electronic system includes a network-on-chip (NoC) and a fault aggregation circuit. The NoC includes a plurality of NoC components that generate faults. The fault aggregation circuit is configured to receive the faults from the NoC components and aggregate and remap the faults into a few alarm levels.

In accordance with various embodiments and aspects herein, a network-on-chip includes a transport interconnect, a plurality of network interface units (NIUs) connected to the transport interconnect, and a fault aggregation circuit. The fault aggregation circuit includes a plurality of input fault aggregators. The NIUs provide faults to the input fault aggregators. Each input fault aggregator aggregates and remaps the faults to a few alarm levels. The fault aggregation circuit further includes an output fault aggregator having inputs operatively coupled to outputs of the input fault aggregators. The output fault aggregator is configured to aggregate alarms from the plurality of input fault aggregators and output a few alarm levels.

In accordance with various embodiments and aspects herein, a circuit for aggregating and remapping faults generated by an electronic system includes a plurality of fault aggregators at an input stage and a fault aggregator at an upstream stage. Each of the fault aggregators at the input stage has a number of fault inputs and logic for remapping faults at the fault inputs into a few alarm levels. The fault aggregator at the upstream stage consolidates the alarm levels from the plurality of fault aggregators at the input stage into a few alarm levels.

### BRIEF DESCRIPTION OF THE DRAWINGS

In order to understand the invention more fully, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1 shows an electronic system including a circuit for aggregating and remapping faults in accordance with various aspects and embodiments herein.

FIG. 2 shows a fault aggregator in accordance with various aspects and embodiments herein.

FIGS. 3, 4 and 5—show various elements of a fault aggregator in accordance with various aspects and embodiments herein.

FIG. 6 shows a circuit for aggregating and remapping faults in accordance with various aspects and embodiments herein.

FIG. 7 shows a method in accordance with various aspects and embodiments herein.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. The examples provided are intended as non-limiting examples. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment of the invention.

Thus, appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future. Furthermore, to the extent that the terms “including”, “includes”, “having”, “has”, “with”, or variants thereof are used in either the detailed description and the claims, such terms are intended to be inclusive in a similar manner to the term “comprising.”

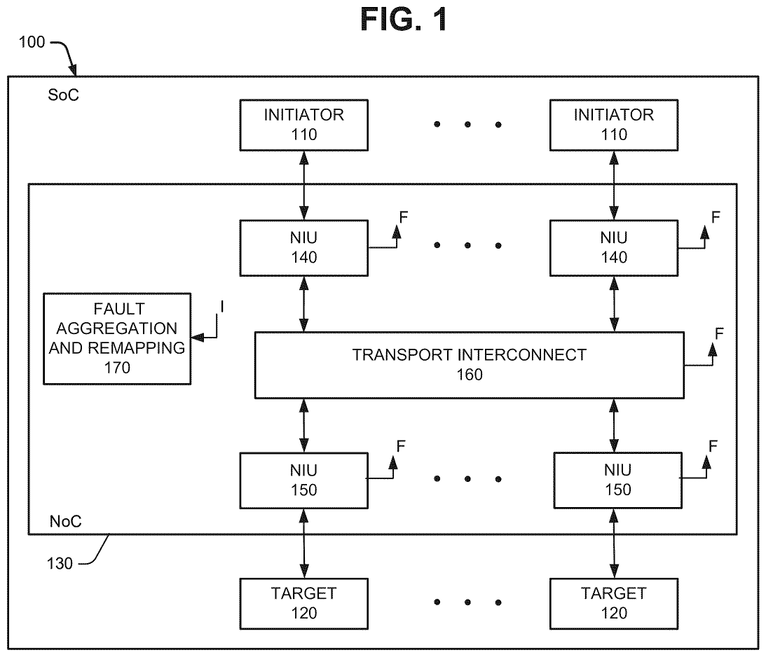

Reference is made to FIG. 1, which illustrates an SoC 100. The SoC 100 includes a plurality of initiators 110 and targets 120. Examples of the initiators 110 include central processing units (CPUs), graphics processing units (GPUs), and accelerators. Examples of the targets 120 include volatile memory, persistent memory, and peripherals.

The SoC 100 further includes a NoC 130. The NoC 130 sends request transactions from an initiator 110 to one or more targets 120 using industry-standard protocols. A request transaction may include an address of the target 120. The NoC 130 decodes the address and transports the request transaction. The target 120 handles the request transaction and may send a response transaction, which is transported back to the initiator 110 via the NoC 130.

The NoC 130 includes a plurality of network interface units (NIUs) 140 and 150 and a transport interconnect 160. Each initiator 110 is coupled to the transport interconnect 160 via a corresponding initiator NIU 140. Each target 120 is coupled to the transport interconnect 160 via a corresponding target NIU 150.

Each NIU 140 or 150 is configured to convert the protocol used by its corresponding initiator 110 or target 120 into a transport protocol used inside the NoC 130. The transport protocol is typically based on the transmission of packets.

The transport interconnect 160 includes switches, adapters, and buffers for transporting packets between the NIUs 140 and 150. Switches may be used to route flows of traffic between source and destinations. Adapters may be used to deal with various conversions between data width, clock and power domains. Buffers may be used to insert pipelining elements to span long distances, or to store packets to deal with rate adaptation between fast senders and slow receivers or vice-versa.

In general, the NoC 130 is highly configurable. Certain NoC components such as the NIUs 140 and 150 and switches may have many different possible configurations. Other NoC components such as buffers may have relatively fewer possible configurations. Parameters of the NoC components may can be varied to optimize the cost, performance, and power consumption.

These NoC components can generate faults such as correctable faults and stuck-at faults. As used herein, correctable faults refer to faults that can be self-corrected. For example, a single bit error in data gives rise to a fault, but the error can be corrected by an error correction code (ECC). As used herein, stuck-at faults refer to faults that cannot be self-corrected. For example, an element of a component is faulty (e.g., a faulty register) and will always output either a ‘0’or a ‘1’.

A fault may be signaled by a pulse on a fault line. In FIG. 1, each NoC component 140-160 has at least one fault line. Each right angle arrow F represents one or more fault lines.

The number of faults generated by the NoC components 140-160 is design specific. A relatively small NoC 130 might generate tens or hundreds of faults. A relatively large NoC 130 might generate thousands of faults.

The NIUs 140 and 150 may have their own clock domains. A clock domain refers to a part of the circuit that is driven by a single clock or by multiple clocks that are related to each other. A clock domain crossing refers to the traversal of a signal from one clock domain to another.

The NoC 130 further includes a fault aggregation circuit 170 that receives the faults from the NoC components 140-160. The right angle arrow I represents a plurality of input lines that receive the faults from the NoC components 140-160.

The fault aggregation circuit 170 is configured to aggregate and remap the faults from the NoC components 140-160 into few levels of alarms. As but one example, the alarm levels may consist of a minor alarm, a major alarm and a critical alarm.

As used herein, the term “remap” means that a fault type can be re-allocated to any other type. The remapping may be customer driven. That is, the customer specifies the alarm level of each fault.

Advantages of the remapping include simplifying the number of faults for reporting purposes, and modifying the level of the alarms so the same system could be adapted to different safety requirements. The remapping can also offer some resilience: If a path for an alarm level is corrupted, all faults of the level can be remapped to another level. For instance, if certain faults are initially remapped to minor alarms, but if the path for the minor alarms is corrupted, those certain faults can be remapped to major alarms. Even though the path is corrupted, alarms are still produced.

Although FIG. 1 shows the fault aggregation circuit 170 within the NoC 130, an electronics system herein is not so limited. In some embodiments, the fault aggregation circuit 170 may be outside of the NoC 130.

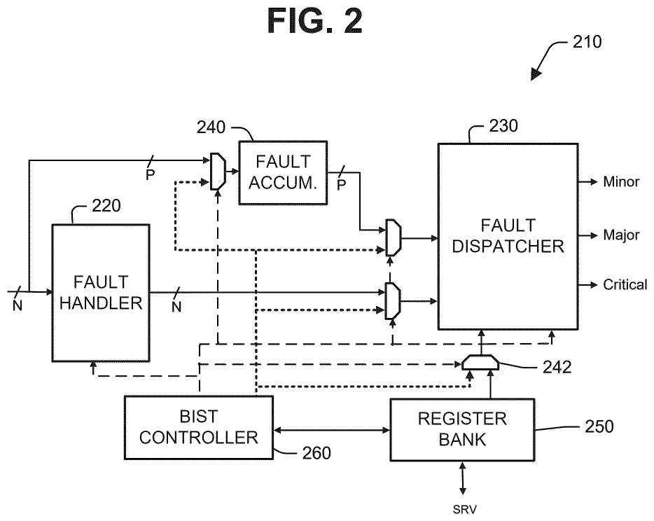

Reference is made to FIG. 2, which illustrates a fault aggregator 210 for the fault aggregation circuit 170. The fault aggregator 210 includes a fault handler 220 configured to receive pulses on its N fault inputs, and transform the pulses to levels.

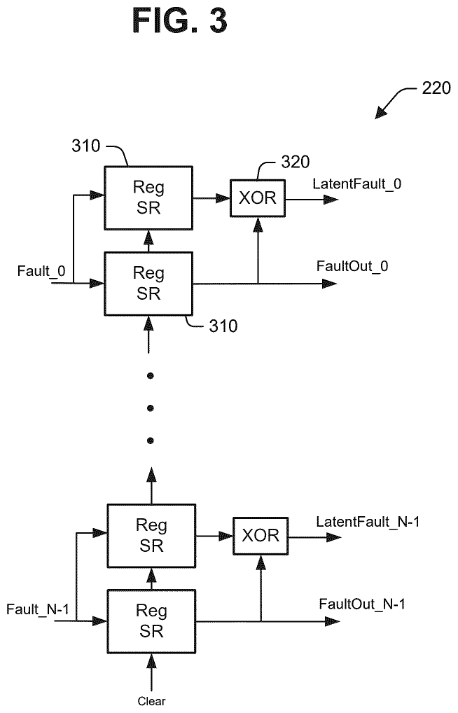

Additional reference is made to FIG. 3, which shows an example of a fault handler 220 including pair of set-reset registers 310 for each of the N fault inputs. Each pair of set-reset register 310 transforms a pulse on its input to a logic level. The set-reset registers 310 of each pair are connected in parallel and outputs of the registers 310 are compared by an XOR gate 320. One of the registers 310 outputs a signal FaultOut and the XOR gate 320 outputs a fault LatentFault. The fault LatentFault may indicate whether the fault FaultOut was itself the by-product of corruption.

As will be discussed below, the fault is stored. Storing the fault gives visibility into the origin of the fault.

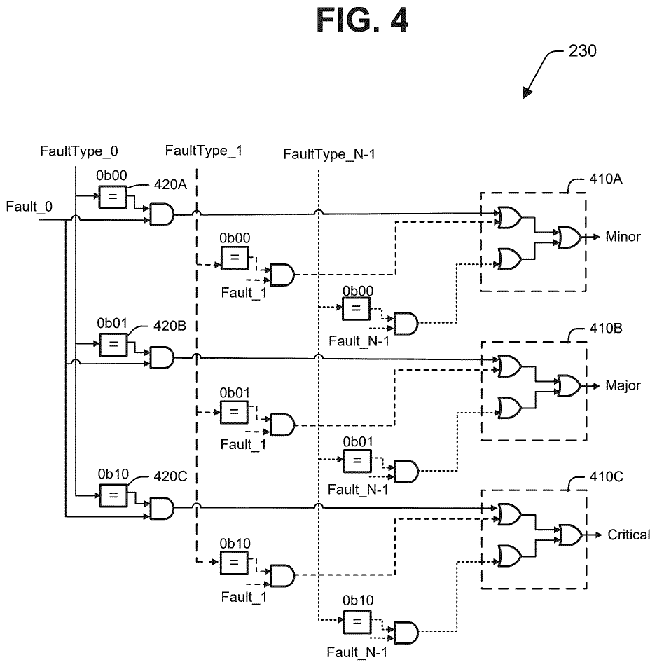

Returning to FIG. 2, the fault aggregator 210 further includes a fault dispatcher 230 for receiving the N fault levels from the fault handler 220 and merging or consolidating the fault levels into a few alarm levels. Additional reference is made to FIG. 4, which shows an example of a fault dispatcher 230 that remaps N faults (Fault_0 to Fault_N−1) into three alarm levels: a minor alarm, a major alarm and a critical alarm. All of the faults (regardless of their level) are OR-ed together in three OR Trees 410A, 410B and 410C. Thus, if any input to the first OR tree 410A goes high, the minor alarm is raised. Similarly, if any input to the second OR tree 410B goes high, the major alarm is raised. If any input to the third OR tree 410C goes high, the critical alarm is raised.

The inputs of the OR-Trees 410A, 410B and 410C are masked by comparators 420A, 420B and 420c. Each comparator 420A, 420B and 420C compares a fault type to a fixed value. In the example of FIG. 4, the value 0b00 corresponds to a minor alarm, the value 0b01 corresponds to a major alarm, and the value 0b10 corresponds to a critical alarm. If Fault_0 should be remapped to a minor alarm, its FaultType_0 is set to 0b00. Similarly, if Fault_0 should be remapped to a major alarm, its FaultType_0 is set to 0b01. If Fault_N−1 should be remapped to a critical alarm, its FaultType_N−1 is set to 0b10. Thus, if a fault of type 0b00 is generated, only the output of comparator 420A goes high, whereby the minor alarm is raised. Such remapping may be customer-defined by setting values of the FaultType_0 to FaultType_N−1.

The fault dispatcher 230 can also cause certain faults to be ignored. Say Fault_0 is a stuck-at fault or a fault that is not meaningful. In the example of FIG. 4, if FaultType_0 is set to the value 0b11, then none of the comparators will go high, and Fault_0 will not cause any of the alarms to raised.

The “OR” in the OR tree refers to operations, not gates. Although FIG. 4 shows OR gates, other types of gates may perform the same operations.

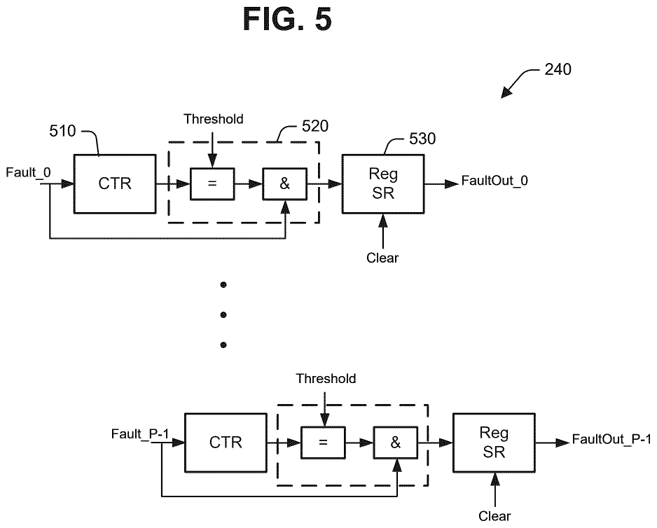

A fault aggregator herein may include additional features. In the example of FIG. 2, the fault aggregator 210 further includes a fault accumulator 240 configured to generate a count for each of P correctable faults. An accumulated fault I issued when the count exceeds a threshold. In the example of fault accumulator 240 of FIG. 5, each correctable fault may have a dedicated counter 510 for keeping a count of the number of times the correctable fault occurred, and logic 520 for determining whether the count exceeds a threshold. A set-reset register 530 outputs an accumulated fault when the count exceeds the threshold. Each accumulated fault is supplied to the fault dispatcher via a switch 242.

In the example of FIG. 2, the fault aggregator 210 further includes a register bank 250. The faults outputted by the fault handler 220 may be stored in registers in the register bank 250. The registers in the register bank 250 may be made visible outside of the NoC 130 via an internal bus SRV of the NoC 130 and a standard bus such as Advanced Peripheral Bus (APB) or Advanced High-performance Bus (AHB) (not shown). The position of a stored fault (that is, the position of the register in which a fault is stored) in the register bank 250 may indicate the source of the fault. For example, a lookup table may use a register position to determine which NIU and which safety mechanism have been triggered. Thus, the register bank 250 provides visibility into the origin of each fault.

In the example of FIG. 2, the fault aggregator 210 further includes a built-in self-test (BIST) controller 260. The BIST controller 260 is configured to test functionality of the fault handler 220, the fault accumulator 240, the register bank 250, and the fault dispatcher 230, and generate internal faults for those components 220-250 that do not pass the BIST. For instance, the fault handler 220 has an expected behavior during BIST. If that expected behavior is not observed, an internal fault is generated. The register bank 250 may be a parity implementation that generates internal faults for any bit flips. Control lines from the BIST controller 260 to the components 220-250 are shown in dash. Internal faults generated by these components 220-250 are provided to switches 242, which forward the internal faults to the fault dispatcher 230 (the switches 242 are controlled by the lines in dot). The internal faults are remapped by the fault dispatcher 230. If the fault dispatcher 230 uses the logic of FIG. 4, the internal faults may be remapped and sent to the OR trees. In addition to being remapped by the fault dispatcher 230, the internal faults may be stored in the register bank 250.

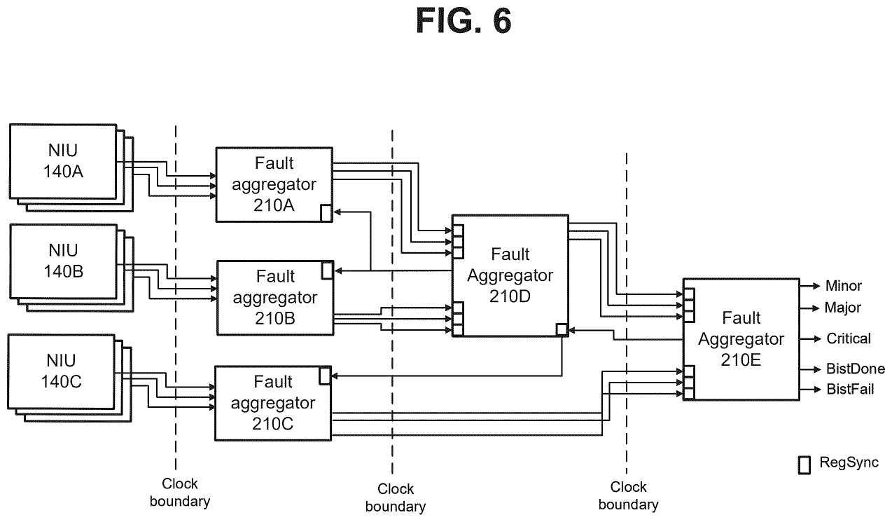

The fault aggregators 210 may be used as building blocks of the fault aggregation circuit 170. The fault aggregation circuit 170 may be scaled upward to handle relatively many (e.g., thousands of) faults by adding fault aggregators 210 and chaining them together such as in the manner illustrated in FIG. 6.

Reference is made to FIG. 6 which illustrates an example of a fault aggregation circuit 170 arranged in three separate stages: an input stage, an intermediate stage upstream of the input stage, and an output stage upstream of the intermediate stage.

The first stage has first, second and third fault aggregators 210A, 210B and 210C. A first NIU 140A provides three faults to the first fault aggregator 210A, a second NIU 140B provides three faults to the second fault aggregator 210B, and a third NIU 140C provides three faults to the third fault aggregator 210C. Each fault aggregator 210A, 210B and 210C has outputs for a minor alarm, a major alarm and a critical alarm.

The NIUs 140A, 104B and 1040C have their own clock domain. The fault aggregators 210A, 210B and 210C of the input stage are in that clock domain. The set-reset registers of their fault handlers 220 transform pulses from the NIUs 140A, 140B and 140C into logic levels.

The intermediate stage has a fourth fault aggregator 210D. Alarm levels from the first and second fault aggregators 210A and 210B are provided to inputs of the fourth fault aggregator 210D. The output stage has a fifth fault aggregator 210E. Alarm levels from the third and fourth fault aggregators 210C and 210D are provided to inputs of the fifth fault aggregator 210E.

The fault aggregators 210D and 210E of the intermediate and output stages may operate in different clock domains than the fault aggregators 210A, 210B and 210C of the input stage. In the fourth and fifth fault aggregators 210D and 210E, registers (other than the set-reset registers 310) of the fault handlers 220 may resynchronize signals crossing to their clock domains.

In the example of FIG. 6, the first, second and third fault aggregators 210A, 210B and 210C may perform fault accumulation. Fault accumulation is not performed in the fourth and fifth fault aggregators 210D and 210E.

The fault handler 220 of the fourth aggregator 210D receives any major, minor and critical alarms from the first fault aggregator 210A, and it receives any major, minor and critical alarms from the second fault aggregator 210B. The fault dispatcher 230 of the fourth fault aggregator 210D consolidates the alarms at its inputs into a few alarm levels. If a minor alarm is received, the fourth fault aggregator 210D outputs a level indicating a minor alarm. Similarly, the fourth fault aggregator 210D outputs a level indicating a major alarm if it receives at least one level indicating a major alarm, and it outputs a level indicating a critical alarm if it receives at least one level indicating a critical alarm.

The fault dispatcher 230 of the fourth fault aggregator 210D may also remap its inputs and provide the remapped inputs to the OR trees. Remapping at the intermediate stage may be performed to address faulty paths between fault aggregators.

The fifth fault aggregator 210E also consolidates the alarms at its inputs to a few alarm levels. It outputs a major alarm if it receives at least one major alarm, a minor alarm if it receives at least one minor alarm, and a critical alarm if it receives at least one critical alarm. However, the fault dispatcher 230 of the fifth fault aggregator 210E does not perform remapping.

The BIST controller 260 of the fifth fault aggregator 210E (of the output stage) controls the BIST performed by all of the fault aggregators 210A-210E. It sends BIST control signals to the third and fourth fault aggregators 210C and 210D. The fourth aggregator 210D (of the intermediate stage) sends BIST control signals to the first and second fault aggregators 210A and 210B of the input stage. When BIST has been completed, the fifth fault aggregator 210E (of the output stage) issue a signal BistDone indicating that BIST is completed and a signal BistFail indicating whether an error was detected.

During BIST, the fault handler 220 and the fault dispatcher 230 are in use and unavailable to handle an incoming fault. The fault handlers 220 of the input stage may have duplicate registers that are not tested during BIST. If a fault is supplied to the input of the fault handler 220 while BIST is being performed, the fault is saved in the duplicate registers. After BIST has been completed, the faults stored in the duplicate registers are aggregated and remapped.

A fault aggregation circuit herein may have many configurations other than the example of FIG. 6. In some embodiments, especially where the NoC components generate only a small number of faults, the fault aggregation circuit may include only a single fault aggregator 210. The single fault aggregator receive pulses on its inputs from the NoC components, and outputs a few alarm levels.

In some embodiments, the fault aggregation circuit does not have an intermediate stage. Instead, all alarm levels generated by fault aggregators at the input stage are supplied directly to inputs of a fault aggregator at the output stage.

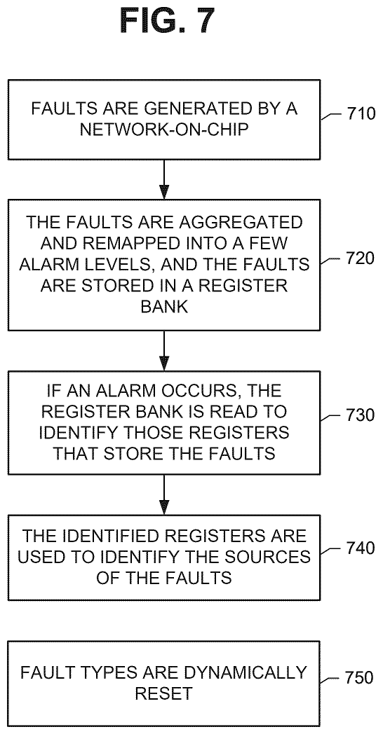

Reference is now made to FIG. 7, which shows a fault handling method. At block 710, faults are generated by a NoC. At block 720, the faults are aggregated and remapped into a few alarm levels. The faults are also stored in registers of a register bank. At block 730, if an alarm occurs, the register bank is read to identify those registers that store the faults. The register bank may be read, for instance, by any initiator 110 that has access granted to the register bank. At block 740, the identified registers are used to identify the sources of the faults. For example, positions of the registers in the register bank may be used as an index to a lookup table, whose entries identify the sources of the faults (that is, the NoC elements that caused the faults).

At block 750, the fault types are dynamically reset. If the fault types (e.g., FaultType_0 to FaultType_N−1 of FIG. 4) are stored in registers of the register bank, the fault types may be reset by changing values of the registers that store the fault types. For instance, if it is desired to change Fault_0 from a minor alarm to a major alarm, the register value for FaultType_0 is changed from 0b00 to 0b01.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Various examples are methods that use the behavior of either or a combination of machines. Method examples are complete wherever in the world most constituent steps occur. For example, IP elements or units include: processors (e.g., CPUs or GPUs), random-access memory (RAM—e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments shown and described herein. Rather, the scope and spirit of present invention is embodied by the appended claims.

What is claimed is:

1. An electronic system comprising:
a network-on-chip (NoC) including a plurality of NoC components that generate faults; and
a fault aggregation circuit that is configured to receive the faults from the NoC components and aggregate the faults to remap the faults into a few alarm levels.

2. The system of claim 1, wherein the fault aggregation circuit includes a number of chained fault aggregators, wherein each fault aggregator has a plurality of fault inputs and logic for remapping faults at the fault inputs into the few alarm levels.

3. The system of claim 2, wherein the NoC includes a plurality of network interface units (NIUs); and wherein each one of the NIUs is configured to provide at least one fault to a corresponding one of the fault aggregators.

4. The system of claim 2, wherein each fault aggregator includes:
a fault handler configured to receive pulses on its inputs and transform the pulses to logic levels; and
a fault dispatcher for remapping and merging the logic levels into the few alarm levels.

5. The system of claim 4, wherein the fault handler includes a plurality of OR trees, one OR tree for each alarm level; and wherein all faults are remapped by comparators and supplied to inputs of the plurality of OR trees.

6. The system of claim 4, wherein at least one of the fault aggregators further includes a fault accumulator configured to generate a count of correctable faults, and issue a fault when the count exceeds a threshold.

7. The system of claim 6, wherein he at least one fault aggregator further includes a built-in self-test (BIST) controller configured to test functionality of the fault handler, the fault accumulator, and the fault dispatcher and generates internal faults for test failure; and wherein the fault handler remaps the internal faults.

8. The system of claim 4, wherein each fault aggregator further includes a register bank configured to stores faults generated by the fault handler.

9. The system of claim 4, wherein the fault dispatcher is configured to dynamically reset the remapping.

10. The system of claim 4, wherein the fault aggregation circuit has an input stage and an output stage; wherein the input stage includes a plurality of fault aggregators whose inputs are arranged to receive the faults from the NoC components; and wherein the output stage includes a single fault aggregator whose inputs are operatively coupled to outputs of the fault aggregators of the input stage and whose outputs provide the few alarm levels.

11. The system of claim 10, wherein the fault aggregators of the input stage include fault handlers having set-reset registers configured to transform pulses representing the faults into logic levels; and wherein the fault aggregator of the output stage includes a fault handler having registers for resynchronizing signals crossing into its clock domain.

12. The system of claim 10, wherein the fault aggregation circuit further has an intermediate stage; and wherein the intermediate stage includes at least one additional fault aggregator whose inputs are arranged to receive alarm levels from the input stage and whose outputs are connected to inputs of the fault aggregator at the output stage.

13. The system of claim 10, wherein each of the fault aggregators includes a built-in self-test (BIST) controller; and wherein the BIST controller of the fault aggregator in the output stage controls the BIST controllers of all downstream fault aggregators.

14. A network-on-chip (NoC) comprising:
a transport interconnect;
a plurality of network interface units (NIUs) connected to the transport interconnect; and
a fault aggregation circuit including:
a plurality of input fault aggregators, wherein the NIUs provide faults to the input fault aggregators and wherein each input fault aggregator aggregates and remaps the faults to a few alarm levels; and
an output fault aggregator having inputs operatively coupled to outputs of the input fault aggregators, the output fault aggregated configured to aggregate alarms from the plurality of input fault aggregators and output the few alarm levels.

15. The NoC of claim 14, wherein each fault aggregator includes:
a fault handler configured to receive pulses on its inputs and transform the pulses to logic levels; and
a fault dispatcher for remapping and consolidating the logic levels into the few alarm levels.

16. The NoC of claim 15, wherein each input fault aggregator further includes a fault accumulator configured to generate a count of correctable faults, and generate a fault when the count exceeds a threshold.

17. The NoC of claim 16, wherein each fault aggregator further includes a register bank configured to stores faults generated by the fault handler, the fault accumulator, and the fault dispatcher.

18. A circuit for aggregating and remapping faults generated by an electronic system, the circuit comprising:
a plurality of fault aggregators at an input stage; and
a fault aggregator at an upstream stage,
wherein each of the fault aggregators at the input stage has a number of fault inputs and logic for remapping faults at the fault inputs into a few alarm levels, and
wherein the fault aggregator at the upstream stage consolidates the few alarm levels from the plurality of fault aggregators at the input stage into the few alarm levels.

19. The circuit of claim 18, wherein each of the fault aggregators at the input stage includes:
a fault handler configured to receive pulses on its inputs and transform the pulses to logic levels; and
a fault dispatcher for remapping and consolidating the logic levels into the few alarm levels.

20. The circuit of claim 19, wherein each of the fault aggregators at the input stage further includes a fault accumulator configured to generate a count of correctable faults, and generate a fault when the count exceeds a threshold.
